(19) United States
(12) Patent Application Publication
(10) Pub. No.: US 2013/0083269 A1
(43) Pub. Date: Apr. 4, 2013

(54) Compound Optical Diaphragm, Backlight Module and Liquid Crystal Display Device

(71) Applicants: Kuangyao Chang, Shenzhen (CN); Hu He, Shenzhen (CN); Lindong Fang, Shenzhen (CN)

(72) Inventors: Kuangyao Chang, Shenzhen (CN); Hu He, Shenzhen (CN); Lindong Fang, Shenzhen (CN)

(21) Appl. No.: 13/379,064

(22) PCT Filed: Oct. 14, 2011
(86) PCT No.: PCT/CN11/80816

§ 371 Date: Dec. 19, 2011

(30) Foreign Application Priority Data
Sep. 30, 2011 (CN) 201110296092.9

(51) Int. Cl. G02F 1/13357; F21V 8/00; G02B 5/02

(52) U.S. Cl. 349/64; 359/599; 362/602

(57) ABSTRACT

The present invention discloses a compound optical diaphragm, a backlight module and a liquid crystal display (LCD) device; the compound optical diaphragm comprises at least two cross brightness enhancement films (BEF*2), wherein a DF with high forward penetration rate is attached to the BEFs. The forward penetration rate of the DF with high forward penetration rate is more than 85% and less than 95%. In the present invention, by completely studying the relationship between the forward penetration rate of the DF and the luminance gain of the overall optical diaphragm in the structure formed by the DF and the cross BEFs, the appropriate range of the forward penetration rate of the DF with high forward penetration rate is determined; the optical effect of the DF is guaranteed; the luminance gain of the compound optical diaphragm is obviously increased; and the appropriate luminance of the backlight module is achieved.

### TECHNICAL FIELD

The present invention relates to the field of liquid crystal displays (LCDs), particularly to a compound optical diaphragm, a backlight module and a LCD device.

### BACKGROUND

The backlight module plays a crucial function in the LCD, and the optical diaphragm used in the backlight module is the key for improving backlight luminance and uniformity. The frequently-used diaphragm mainly comprises diffuser (comprising Up Diffuser and Diffuser (DF), brightness enhancement film (BEF) (comprising prism and lenticular), micro-lens (ML), dual brightness enhancement film (DBEF) and the like. However, when the single diaphragm is used, high luminance is required; the cost is high; the high-power backlight source is required; high heat is released and the heat is gathered near the light-bar; and the display quality and the service life of the device are affected. How to use the appropriate diaphragm combination so that the luminance gain is optimized becomes the key point of backlight design. At present, the DBEF combination is not used, the maximum luminance gain (from bottom to top): prism (90°), prism (0°), Up Diffuser (penetration rate is more than 95%); the structure of the two cross BEFs will cause the visual angle to be too small. If the visual angle is more than 40°, the luminance is reduced by more than 80%. However, the structure is often used by the notebook computer (personal computer display). Because of the small visual angle, the structure is not applicable to the backlight design of the television watched by many people together. Refer to FIG. 1 for the relationship between the luminance and visual angle of the structure.

The Chinese patent application number 200910127865.3 discloses a compound optical diaphragm; its structure is shown in FIG. 2: the compound optical diaphragm comprises a first group of prism 3 and a second group of prism 2; the first group of prism 3 and the second group of prism 2 are crosswise arranged; and the first group of prism 3 and the second group of prism 2 are provided tops with smooth curved surfaces; the compound optical diaphragm 4 is arranged below the first group of prism 3 and the second group of prism 2 to be used as a diffuser; and the light emitted by the backlight source 6 reaches to the LCD panel 1 through the transparent support plate 5 and then through the compound optical diaphragm 4. Although both the problem of visual angle caused by the two cross BEFs and the problem of mura effect the netted dot mura of the light guide plate are solved by adding the diffuser, after the diffuser is added, the overall luminance of the structure of DF plus two of BEFs is obviously reduced. Therefore, it is necessary to further study how to solve the problems of narrow visual angle and the netted dot mura of the light guide plate and how to reduce the luminance loss.

### SUMMARY

The aim of the present invention is to provide a compound optical diaphragm, a backlight module and a LCD device thereof with wide visual angle, preferable LGP display taste and high luminance.

The purpose of the present invention is achieved by the following technical schemes.

A compound optical diaphragm comprises at least two mutually cross BEFs, wherein, the DF with high forward penetration rate is attached to said BEFs; the forward penetration rate of said DF with high forward penetration rate is more than 85% and less than 95%.

Preferably, each said BEF is a multiple-prism BEF. The cost is low under the condition that higher luminance gain is guaranteed when the multiple-prism BEF of Cross BEF structure is used.

Preferably, one or both of the prism and the lenticular are selected by said at least two cross BEFs.

Preferably, the prism angle of said BEFs is 90°±5°.

Preferably, said DF with high forward penetration rate is arranged under the BEFs.

Preferably, said DF with high forward penetration rate is arranged above the BEFs.

Preferably, the DBEF is also arranged above said BEFs.

Preferably, said compound optical diaphragm comprises a DF, a first prism arranged above the DF, and a second prism which is arranged above the first prism and forms an included angle of 90° with the first prism. Research and analysis show that the luminance gain of the optical diaphragm structure is the best.

A backlight module comprises a backlight source and a light guide plate, wherein the aforementioned compound optical diaphragm is arranged on said light guide plate.

A LCD device comprises a LCD panel, and said LCD device also comprises the aforementioned backlight module.

In the present invention, by completely studying the relationship between the forward penetration rate of the DF and the luminance gain of the overall optical diaphragm in the structure formed by the DF and the cross BEFs, when the forward penetration rate of the DF with high forward penetration rate is determined within the range of more than 85% and less than 95%, the optical effect of the DF is guaranteed; for example, the problems of netted dot mora, etc. are solved by adding the diffuser, the luminance gain of the compound optical diaphragm is obviously increased, and the appropriate luminance of the backlight module is achieved.

### BRIEF DESCRIPTION OF FIGURES

FIG. 1 is the schematic diagram of the relationship between the luminance and the visual angle of the diaphragm combination structure without DBEF;

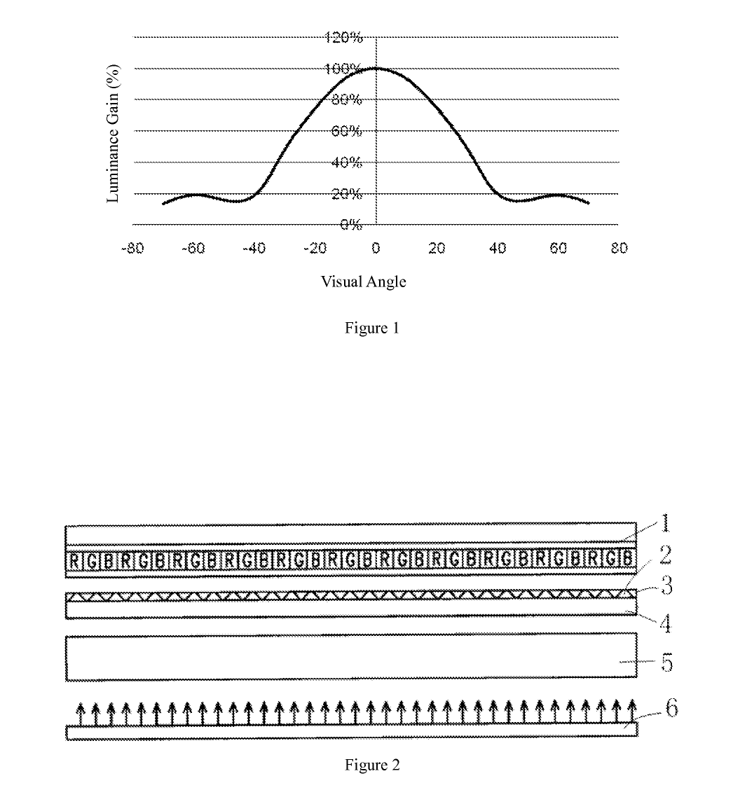

FIG. 2 is the structural diagram of the compound optical diaphragm of the prior art;

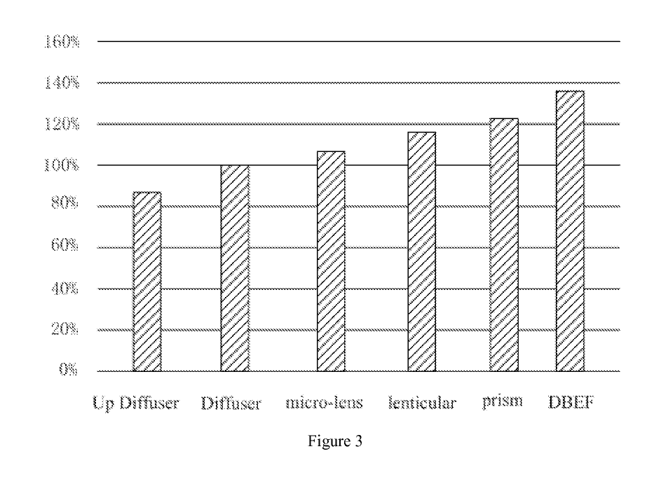

FIG. 3 is the comparison diagram of the separate luminance gains of various optical diaphragms; and

FIG. 5 is the schematic diagram of the luminance gain of the DF with different forward penetration rates in the cross BEF structure.

Wherein: 1, LCD panel; 2. the second group of prism; 3. the first group of prism; 4. compound optical diaphragm; 5.transparent support plate; 6.backlight source;

Up Diffuser; Diffuser (DF); lenticular; prism; DBEF; BEF;

LTC_{—}0 (the lenticular is positioned at an angle of 0°; LTC_{—}90 (the lenticular is positioned at an angle of 90°);

PR_{—}0 (the prism is positioned at an angle of 0°); PR_{—}90 (the prism is positioned at an angle of 90°);

### DETAILED DESCRIPTION

The present invention will further be described in detail in accordance with the figures and the preferred embodiments.

The LCD device comprises a LCD panel with a backlight module; and the backlight module usually comprises a backlight source, a light guide plate and a compound optical diaphragm. The present invention aims to obtain a compound optical diaphragm which has the advantages of wide visual angle, preferable LGP display taste and high luminance, and meets the preferable luminance requirement of the LCD device by studying various diaphragms of the optical diaphragms of various structures.

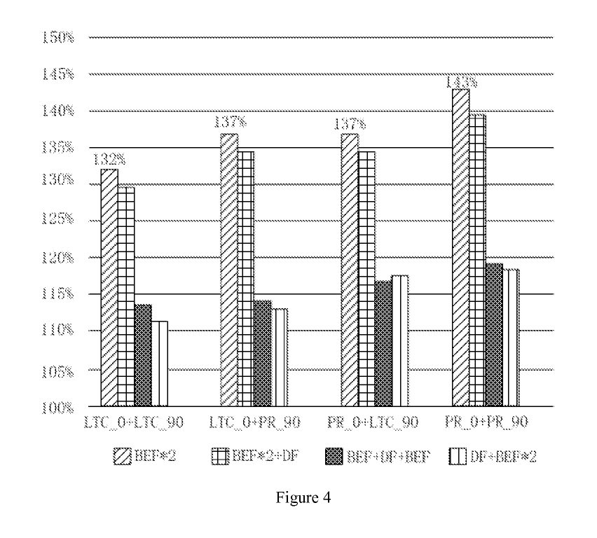

The common optical diaphragm in the market at present comprises: lenticular, prism, DBEF and the like; FIG. 3 shows the luminance gain brought by individually using various frequently-used diaphragms. However, the luminance gain is affected by various factors, and the luminance gain brought by a group of compound optical diaphragms is different from the luminance gain brought by each single diaphragm.

For the optical diaphragm which comprises at least two mutually cross BEFs to which the DF is attached, its visual angle and LGP display taste are preferably achieved; however, its luminance is reduced because the DF is used.

FIG. 4 shows the schematic diagram of luminance gain of four optical diaphragm structures: the two BEFs are mutually and crosswise arranged (BEF*2); the DF is arranged above the two BEFs which are mutually and crosswise arranged (BEF*2+DF); the DF is arranged between the two BEFs which are mutually and crosswise arranged (BEF+DF+BEF); and the DF is arranged below the two BEFs which are mutually and crosswise arranged (DF+BEF*2). Wherein, the prism (prism is represented by PR in the Figure) or the lenticular (lenticular is represented by LTC in the Figure) can be selected by the BEFs. It is known from the data shown in the Figure, the luminance gain of the two prisms which are mutually perpendicular in the prism direction is the best; no matter in which structure, after the Diffuser is added, the overall luminance gains of the compound optical diaphragm is obviously reduced.

In the Cross BEF structure which comprises at least two cross BEF and is attached with DF, by study, because the upper surface of the BEF is of horizontal or vertical prism structure, the structure will gather the vertical or horizontal light to the center; the light gathered by BEF will be scattered or reflected when passing through other diffusers; the elevation gain will be attenuated, and a part of light will be absorbed by the diaphragm material. Therefore, the diffuser is used: DF, the forward penetration rate of the diffuser has an influence on the luminance gain of the overall diaphragm structure. Wherein, said forward penetration rate is the ratio of the emergent light intensity of the diaphragm to the incident light intensity, namely: Tr %=I emergent light/I incident light.

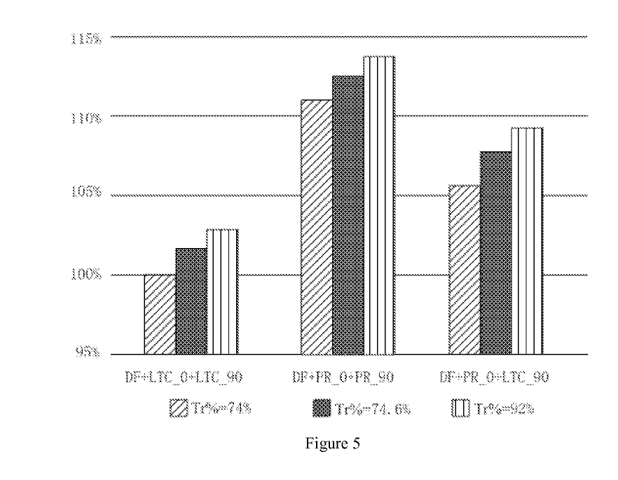

Thus, in the Cross BEF structure, the forward penetration rate of the added DF and the luminance of the integral compound optical diaphragm are studied: as shown in FIG. 5, the condition that the DF of DI-700A type is additionally arranged below the two mutually cross BEFs (DF+BEF*2) is used as an embodiment; the compound optical diaphragm of DI-700A+LTC _{—}90+LTC_{—}0 structure is used as a standard; and then the overall luminance gain changing condition of the diaphragm under the condition of various forward penetration rates is analyzed. It is known from the data shown in the figure that the optical diaphragm luminance gain will be correspondingly increased with the increase of the forward penetration rate. Wherein, the first prism (PR_{—}0) is arranged on one DF, and then the second prism (PR_{—}90) which forms an included angle of 90° with the prism of the first prism is arranged on the first prism. The luminance gain of such optical diaphragm structure is the best. The visible luminance gain is increased with the increase of the penetration rate of the DF. By comprehensively considering the mura shielding effect of the diaphragm, the frequently-used DF (the penetration rate is from 72 to 80%), and the frequently-used Up Diffuser (the penetration rate is more than 95%) are avoided by the structure; under the condition of the structure of cross prisms, the DF whose forward penetration rate is more than 85% and less than 95% is used to achieve the optimized luminance, taste and visual angle.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A compound optical diaphragm, comprising: at least two mutually cross brightness enhancement films (BEFs); a Diffuser (DF) with high forward penetration rate is attached to said BEFs; the forward penetration rate of said DF is more than 85% and less than 95%.

2. The compound optical diaphragm of claim 1, wherein each said BEF is a multiple-prism BEF.

3. The compound optical diaphragm of claim 2, wherein one or both of the prism and the lenticular are selected by said at least two cross BEFs.

4. The compound optical diaphragm of claim 1, wherein the prism angle of said BEFs is 90°±5°.

5. The compound optical diaphragm of 1, wherein said DF is arranged below the BEFs.

6. The compound optical diaphragm of 1, wherein said DF is arranged above the BEFs.

7. The compound optical diaphragm of claim 1, wherein the dual brightness enhancement film (DBEF) is arranged above said BEFs.

8. The compound optical diaphragm of claim 4, wherein said compound optical diaphragm comprises a DF, a first prism arranged above the DF, and a second prism which is arranged above the first prism and forms an included angle of 90° with the first prism.

9. A backlight module, comprising: a backlight source and a light guide plate, the compound optical diaphragm of claim 1 is arranged on said light guide plate; said compound optical diaphragm comprises at least two cross BEFs, and a DF with high forward penetration rate is attached to said BEFs; the forward penetration rate of said DF is more than 85% and less than 95%.

10. The backlight module of claim 9, wherein each BEF is a multiple-prism BEF.

11. The backlight module of claim 10, wherein one or both of the prism and the lenticular are selected by said at least two cross BEFs.

12. The backlight module of claim 9, wherein the prism angle of said BEFs is 90°±5°.

13. The backlight module of claim 9, wherein said DF is arranged below the BEFs.

14. The backlight module of claim 9, wherein said DF is arranged above the BEFs.

15. The backlight module of claim 9, wherein the DBEF is arranged above said BEFs.

16. The backlight module of claim 12, wherein said compound optical diaphragm comprises a DF, a first prism arranged above the DF, and a second prism which is arranged above the first prism and forms an included angle of 90° with the first prism.

17. A liquid crystal display (LCD) device, comprising: a LCD panel; said LCD device comprises a backlight module of claim 9; said backlight module comprises a backlight source and a light guide plate, and the compound optical diaphragm is arranged on the light guide plate; said compound optical diaphragm comprises at least two mutually cross BEF, and the DF with high forward penetration rate is attached to said BEFs; the forward penetration rate of said DF is more than 85% and less than 95%.

18. The LCD device of claim 17, wherein each said BEF is a multiple-prism BEF.

19. The LCD device of claim 18, wherein one or both of the prism and the lenticular are selected by said at least two cross BEFs.

20. The LCD device of claim 17, wherein the prism angle of said BEFs is 90°±5°.

21. The LCD device of claim 17, wherein said DF is arranged below the BEFs.

22. The LCD device of claim 17, wherein said DF is arranged above the BEFs.

23. The LCD device of claim 17, wherein the DBEF is arranged above said BEFs.

24. The LCD device of claim 20, wherein said compound optical diaphragm comprises a DF, a first prism arranged above the DF, and a second prism which is arranged above the first prism and forms an included angle of 90° with the first prism.
